(19) United States
(12) Patent Application Publication
(10) Pub. No.: US 2026/0365235 A1
(43) Pub. Date: Nov. 19, 2026

(54) STEER-BY-WIRE STEERING SYSTEM COMPRISING NETWORKED SUB-SYSTEMS, AND METHOD FOR OPERATING SUCH A STEER-BY-WIRE STEERING SYSTEM

(71) Applicants: thyssenkrupp Presta AG, Eschen (LI); thyssenkrupp AG, Essen (DE)

(72) Inventors: Andras TOTH, Gyál (HU); Miklós ARÁNYI, Altstaetten (CH); Imre SZEPESSY, Mauren (LI); Bence BODNÁR, Kiskunfélegyháza (HU); Mária BEKÓ, Kimle (HU)

(73) Assignees: thyssenkrupp Presta AG, Eschen (LI); thyssenkrupp AG, Essen (DE)

(21) Appl. No.: 19/154,457

(22) PCT Filed: Feb. 6, 2024
(86) PCT No.: PCT/EP2024/052863

§ 371 Date: Aug. 7, 2025

(30) Foreign Application Priority Data
Feb. 10, 2023 (BE) BE 2023/5099

(51) Int. Cl. B62D 5/04; B62D 15/02

(52) U.S. Cl. CPC B62D 5/0484; B62D 5/0493; B62D 15/0215

(57) ABSTRACT

A steer-by-wire steering system for a motor vehicle comprises a first subsystem and a second subsystem, wherein the first subsystem comprises a steering shaft, a steering handle arranged in a rotationally fixed manner at one end of the steering shaft, a feedback actuator, an absolute angle sensor unit for determining an absolute steering angle of the steering shaft, and a relative angle sensor unit for determining a relative steering angle of the steering shaft, and wherein the second subsystem comprises a steering actuator unit, a coupling element, an absolute position sensor unit for determining an absolute position of the coupling element, and a relative position sensor unit for determining a relative position of the coupling element. To increase the error robustness, the first subsystem and the second subsystem are connected to one another via a communication connection, wherein the communication connection is configured to transmit sensor data from the first subsystem to the second subsystem and to transmit sensor data from the second subsystem to the first subsystem.

The invention relates to a steer-by-wire steering system for a motor vehicle having a first subsystem and a second subsystem, wherein the first subsystem comprises a steering shaft, a steering handle arranged in a rotationally fixed manner at one end of the steering shaft, a feedback actuator, an absolute angle sensor unit for determining an absolute steering angle of the steering shaft, and a relative angle sensor unit for determining a relative steering angle of the steering shaft, and wherein the second subsystem comprises a steering actuator unit, a coupling element, in particular a rack, an absolute position sensor unit for determining an absolute position of the coupling element, and a relative position sensor unit for determining a relative position of the coupling element. Furthermore, the invention relates to a method for operating such a steer-by-wire steering system.

Steer-by-wire steering systems are widely described in the prior art. For example, DE 10 2018 114 988 A1 discloses a steer-by-wire steering system having a steering handle, a feedback actuator, and a steering actuator, wherein a steering command can be specified via the steering handle, which can be converted by the steering actuator into a steering movement of steerable wheels of a motor vehicle. One challenge in steer-by-wire steering systems is to keep a motor vehicle controllable even upon an occurrence of faults in the steer-by-wire steering system. DE 10 2020 100 719 A1 proposes for this purpose switching off the faulty steering system in a motor vehicle having a front axle steering system and a rear axle steering system in the case of error of the front axle steering system or the rear axle steering system and enabling a steering movement by means of an autonomous driving mode or a derived setpoint movement. Moreover, it is known from DE 10 2019 217 588 A1 that after a vehicle collision, due to which one or more wheels of a vehicle axle are no longer completely steerable or are also no longer steerable at all, steering is performed by means of the functional steering axle and a braking signal is transmitted to one of the vehicle wheels connected to this steering axle. In addition, designing components of the steer-by-wire steering system as redundant is known, so that in the case of an occurrence of a fault in a component, the corresponding function of this component is executed by the redundant component. For example, in DE 10 2020 209 270A1, a redundantly designed control unit is disclosed which can be used in a steer-by-wire steering system. A redundant design of components of a steer-by-wire steering system is also disclosed in US 2022/0001916A1.

Furthermore, DE 10 2004 008 203 A1 discloses a system and a method for the initial alignment of the wheels of a steer-by-wire steering system of a motor vehicle. This steer-by-wire steering system in this case comprises a first subsystem having a steering shaft, having a steering handle arranged at the steering shaft, having a steering wheel actuator having associated motor output stage, having an absolute angle sensor unit for determining an absolute steering angle of the steering shaft, having a relative sensor unit for determining a relative steering angle of the steering shaft, and having a steering wheel controller. Moreover, the steer-by-wire steering system comprises a second subsystem having steerable wheels which can be steered by a wheel actuator associated with the respective steerable wheel, wherein the wheel actuators are controlled via a respective motor output stage by a wheel controller. The second subsystem comprises wheel sensors for determining a relative and an absolute wheel angle. Sensor data can be transmitted between the steering wheel controller of the first subsystem and the wheel controller of the second subsystem.

A similar steer-by-wire steering system is described in DE 10 2004 030 685A1. The steer-by-wire steering system is configured here such that model-based error recognition is enabled, wherein instead of additional hardware components, analytical redundancy is used in order to reduce costs and increase the reliability in this way.

Proceeding herefrom, there is a further demand to keep a motor vehicle having a steer-by-wire steering system controllable in the event of errors occurring in or at the steering system, and thus further reduce the risk for personal damage.

Against this background, it is an object of the present invention to further improve a steer-by-wire steering system and a method for operating a steer-by-wire steering system, and in particular to find a cost-efficient method to eliminate possible errors in the measurement of fundamental parameters in a steer-by-wire system.

A steer-by-wire steering system as claimed in claim 1 and a method for operating a steer-by-wire steering system as claimed in the other independent claim are proposed to achieve this object. Further advantageous embodiments of the invention are described in the dependent claims and the description and shown in the figures.

The proposed solution provides a steer-by-wire steering system for a motor vehicle having a first subsystem and a second subsystem. The first subsystem comprises a steering shaft, a steering handle arranged in a rotationally fixed manner at one end of the steering shaft, in particular a steering wheel, a feedback actuator, an absolute angle sensor unit for determining an absolute steering angle of the steering shaft, and a relative angle sensor unit for determining a relative steering angle of the steering shaft. In particular, a rotor position sensor unit associated with an electric motor of the feedback actuator is provided as the relative angle sensor unit. The second subsystem comprises a steering actuator unit, a coupling element, in particular a rack, an absolute position sensor unit for determining an absolute position of the coupling element, and a relative position sensor unit for determining a relative position of the coupling element. In particular, a rotor position sensor unit associated with an electric motor of the steering actuator unit is provided as the relative position sensor unit. According to the invention, in the steer-by-wire steering system, the first subsystem and the second subsystem are connected to one another via a communication connection, wherein the communication connection is configured to transmit sensor data from the first subsystem to the second subsystem and to transmit sensor data from the second subsystem to the first subsystem. The exchange of sensor data between the subsystems is advantageously improved by this design, wherein advantageously, in particular in the event of a failure of one of the subsystems, sensor data can be provided in an improved manner to the still functional subsystem. In particular, it is provided that the communication connection is designed as redundant.

According to a particularly advantageous refinement, the steer-by-wire steering system comprises a third subsystem, wherein the third subsystem comprises an interface to a backup steering system, and wherein the communication connection is advantageously furthermore configured to transmit sensor data from the first subsystem and/or from the second subsystem to the third subsystem. The interface is advantageously configured here to transmit sensor data transmitted to the third subsystem to the backup steering system. The backup steering system is advantageously formed by one or preferably multiple vehicle assemblies, which are used deviating from the original task for implementing a steering specification. In particular, a correspondingly actuated braking system and/or a correspondingly actuated drive system and/or a correspondingly actuated active chassis can be comprised by the backup steering system. In the event of a failure of the steer-by-wire steering system, which makes it necessary to steer a motor vehicle by means of the backup steering system, sensor data relevant for steering the motor vehicle can advantageously be transmitted here via the communication connection to the third subsystem and thus to the backup steering system and therefore the functionality of the backup steering system can be improved. In particular, an overall steering system is provided which comprises the steer-by-wire steering system and the backup steering system, wherein in this design the third subsystem is comprised by the overall steering system and in particular comprises the backup steering system. This overall steering system can be designed here in particular as a steer-by-wire steering system according to the invention having a supplemented backup steering system.

One embodiment variant provides in particular that a control unit, in particular an ECU (ECU: Electronic Control Unit), is associated with each of the subsystems. Either each subsystem can comprise a control unit here. However, an advantageous embodiment provides a central control unit, wherein control subunits of this central control unit are each assigned to the subsystems as a control unit.

One advantageous embodiment of the steer-by-wire steering system provides that the communication connection is implemented by a vehicle communication network, in particular CAN (CAN: Controller Area Network) and/or by a private communication channel between the subsystems. In particular, it is provided that a high-level communication connection is used as the communication connection. In particular, it is provided that the communication connection is at least implemented on a layer 2 level with respect to the ISO/OSI reference model. The communication connection is preferably implemented as wired. However, according to one embodiment variant, a completely or partially wirelessly formed communication connection, in particular a radio connection, is also provided.

Furthermore advantageously, the second subsystem of the steer-by-wire steering system, in particular the steering actuator unit of the second subsystem, is designed to receive angle measured values provided by the absolute angle sensor unit comprised by the first subsystem, in particular via a first direct communication interface to the absolute angle sensor unit. Angle measured values captured here by the absolute angle sensor unit are advantageously transmitted directly to the second subsystem, in particular directly to the steering actuator unit, in particular to a control unit associated with the steering actuator unit. In particular, the absolute angle sensor unit is wired directly with the second subsystem here. The second subsystem is therefore advantageously designed to directly receive steering information required for setting a correct wheel steering angle. In particular, it is provided as an embodiment variant that the first communication interface is not comprised by the communication connection, but rather is formed separately.

The second subsystem, in particular the steering actuator unit, is advantageously furthermore designed to provide the absolute angle sensor unit with the energy required for operation, advantageously via the direct connection, in particular via the first direct communication interface. Advantageously, a voltage required for the operation of the absolute angle sensor unit is provided in a manner controlled by the second subsystem here. The absolute angle sensor unit is insofar advantageously not dependent on an energy supply by the first subsystem.

According to a further advantageous embodiment of the steer-by-wire steering system, the first subsystem is designed to receive position measured values provided by the absolute position sensor unit, in particular via a second direct communication interface to the absolute position sensor unit. In particular, the absolute position of the coupling element of the second subsystem and therefore ultimately a set wheel steering angle of steered wheels of the motor vehicle results from these position measured values. Position measured values captured by the absolute position sensor unit are advantageously transmitted here directly to the first subsystem, in particular directly to the feedback actuator, furthermore in particular directly to a control unit assigned to the first subsystem. In particular, the absolute position sensor unit is wired directly with the second subsystem here. The first subsystem is therefore advantageously designed to receive directly position measured values with respect to a specific position of the coupling element, and therefore in particular information with respect to a set wheel steering angle. In particular, it is provided as a design variant that the second communication interface is not comprised by the communication connection, but rather is formed separately. Furthermore in particular, the first communication interface and the second communication interface can be assigned to a common communication channel.

The first subsystem is advantageously designed to provide the absolute position sensor unit with the energy required for operation, advantageously via the direct connection, in particular via the second direct communication interface. In particular, a voltage required for the operation of the absolute position sensor unit is provided in a manner controlled by the first subsystem here. The absolute position sensor unit is advantageously insofar not dependent on an energy supply by the second subsystem.

A further advantageous embodiment provides that the steer-by-wire steering system is designed for operation in a motor vehicle in different operating modes. In particular, the steer-by-wire steering system is configured in a first operating mode for error-free operation of the steer-by-wire system. This first operating mode is the normal operating mode here, in which the steer-by-wire steering system is typically operated.

Furthermore in particular, the steer-by-wire steering system is configured in a second operating mode for operation in the event of a failure, in particular a complete failure, of the first subsystem. This second operating mode advantageously provides that the steer-by-wire steering system continues to steer a motor vehicle using the second subsystem, even if the first subsystem has failed.

Furthermore in particular, the steer-by-wire steering system is designed in a third operating mode for operation in the event of a failure, in particular a complete failure, of the second subsystem, in particular the steering actuator unit of the second subsystem. This third operating mode advantageously provides that the steer-by-wire steering system steers a motor vehicle using a backup steering system if the second subsystem, in particular the steering actuator unit, has failed. Sensor data captured by sensors of the first subsystem and the second subsystem are advantageously provided to the backup steering system here by the first subsystem, in particular information with respect to an absolute angle of the steering shaft and information with respect to an absolute position of the coupling element.

The method furthermore proposed for operating a steer-by-wire steering system in a motor vehicle, in particular a steer-by-wire steering system, designed as claimed in any one of claims 1 to 9, in a motor vehicle, provides that in a first operating mode configured for error-free operation, the second subsystem captures an angle measured value provided by the absolute angle sensor unit, the second subsystem converts the captured angle measured value into corresponding angle information, and the second subsystem provides the angle information via the communication connection to the first subsystem. In addition, the angle information is advantageously also provided to the third subsystem. The angle information is in particular sensor data in the meaning of the present invention here. The first subsystem of the steer-by-wire steering system in particular comprises in this case a steering shaft, a steering handle arranged in a rotationally fixed manner at one end of the steering shaft, a feedback actuator, an absolute angle sensor unit for determining an absolute steering angle of the steering shaft, and a relative angle sensor unit for determining a relative steering angle of the steering shaft. The second subsystem in particular comprises a steering actuator unit, a coupling element, an absolute position sensor unit for determining an absolute position of the coupling element, and a relative position sensor unit for determining a relative position of the coupling element. The third subsystem in particular comprises an interface to a backup steering system, wherein the backup steering system is implemented in particular by an actuation of active vehicle components, in particular by an actuation of brakes assigned to the wheels of the motor vehicle, of drive units, and/or of active chassis components. In that the second subsystem captures an angle measured value provided by the absolute angle sensor unit, this angle measured value is advantageously available to the second subsystem even in the event of an at least partial failure of the first subsystem. In error-free normal operation, the first subsystem advantageously processes the angle information transmitted to the first subsystem via the communication connection.

In particular, it is provided that the first subsystem captures the angle information provided via the communication connection and determines an absolute steering shaft angle from this angle information and a relative angle of the steering shaft captured by means of the relative angle sensor unit. This determination of the absolute steering shaft angle advantageously takes place upon (re-)startup, in order to initially determine the absolute steering shaft angle. For the further operation, it is provided in particular that a determination of the absolute steering shaft angle is at least alternatively also ascertained in consideration of the initially determined absolute steering shaft angle and a captured relative angle of the steering shaft.

According to a further advantageous embodiment, in the first operating mode configured for error-free operation, the first subsystem captures a position measured value provided by the absolute position sensor unit, wherein the first subsystem advantageously converts the captured position measured value into corresponding position information with respect to a position of the coupling element, wherein the first subsystem advantageously provides the position information to the second subsystem via the communication connection. In addition, the position information is advantageously also provided to the third subsystem. The position information is in particular sensor data in the meaning of the present invention here. The position measured values are thus advantageously available to the first subsystem even in the event of an at least partial failure of the second steering system, and can be made available in particular as position information to the third subsystem and therefore in particular a backup steering system of the motor vehicle, so that, advantageously, improved maneuvering of the motor vehicle is enabled using the backup steering system in the event of a failure of the second steering system.

In particular, it is provided that the second subsystem, in particular the steering actuator unit of the second subsystem, furthermore in particular an evaluation unit assigned to the steering actuator unit, captures the position information provided via the communication connection, and advantageously determines an absolute coupling element position from this position information and a relative position of the coupling element captured by means of a relative position sensor unit. This determination of the absolute coupling element position advantageously takes place upon (re-)startup of the steer-by-wire steering system in order to initially determine the absolute coupling element position. For the further operation it is provided in particular that a determination of the absolute coupling element position is at least alternatively also ascertained in consideration of the initially determined absolute coupling element position and a captured relative position of the coupling element.

According to an advantageous refinement of the method, it is provided that in a third operating mode, in which the motor vehicle is steered by means of a backup steering system due to an error in the second subsystem, the first subsystem determines an absolute angle of the steering shaft based on a relative angle of the steering shaft captured by means of the relative angle sensor unit and a previously determined absolute steering shaft angle, this determined absolute angle of the steering shaft is advantageously provided together with the converted position information to the third subsystem, wherein the interface of the third subsystem advantageously forwards the determined absolute angle and the position information to the backup steering system. The absolute steering shaft angle was in particular determined here during error-free operation. The information transmitted to the third subsystem, in particular the absolute angle of the steering shaft and the position information, is in particular sensor data in the meaning of the present invention. By means of the sensor data thus transmitted, the backup steering system is advantageously configured in an improved manner to maneuver the motor vehicle according to a steering specification.

A further advantageous embodiment of the method provides that in a second operating mode, in which the first subsystem cannot provide position information due to an error in the first subsystem, the second subsystem determines the absolute coupling element position based on a relative position of the coupling element captured by means of the relative position sensor unit and a previously determined absolute coupling element position, wherein information with respect to an absolute angle of the steering shaft is captured directly by the absolute angle sensor unit. The absolute coupling element position was determined here in particular during error-free operation. A motor vehicle thus advantageously remains steerable by means of the second subsystem even upon an occurrence of a severe error in the first subsystem.

According to a further embodiment, a proposed steer-by-wire steering system is advantageously furthermore designed for operation according to a method designed according to the invention.

Further advantageous details, features, and design details of the invention will be explained in more detail in conjunction with the exemplary embodiments shown in the figures. In the figures:

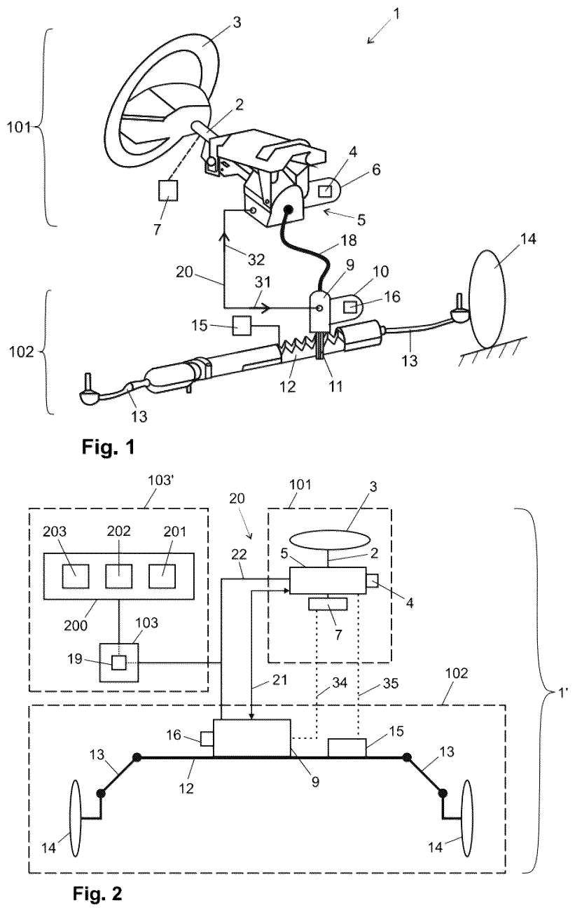

FIG. 1 shows a simplified perspective view of an exemplary embodiment for a steer-by-wire steering system designed according to the invention;

FIG. 2 shows a simplified schematic view of a further exemplary embodiment for a steer-by-wire steering system designed according to the invention; and

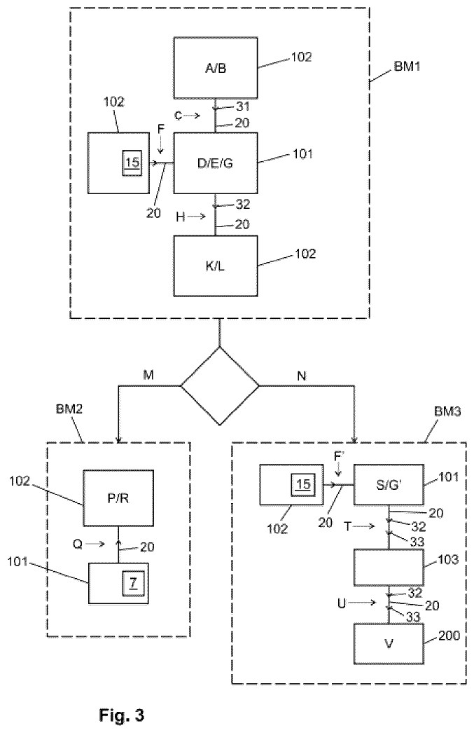

FIG. 3 shows a block diagram of an exemplary embodiment for a method designed according to the invention for operating a steer-by-wire steering system.

In the different figures, identical parts are generally provided with identical reference signs and are therefore sometimes each also explained only in conjunction with one of the figures.

FIG. 1 shows an exemplary embodiment for a steer-by-wire steering system 1, designed according to the invention, for a motor vehicle having a first subsystem 101 and a second subsystem 102. The first subsystem 101 of the steer-by-wire steering system 1 comprises a steering column having a steering shaft 2 and a feedback actuator 5. A steering handle 3 designed as a steering wheel is arranged in a rotationally fixed manner at one end of the steering shaft 2. A vehicle user can specify a steering command via the steering handle 3. The feedback actuator 5 is designed to exert a torque or a steering resistance torque on the steering shaft 2, in particular to convey a steering feeling. This steering resistance torque is perceptible by a vehicle user of the motor vehicle via the steering handle 3 as steering resistance.

The steering handle 3 of the steer-by-wire steering system 1 can be rotated in a known manner to introduce a steering command into the steering shaft 2, which is captured by sensor. For this purpose, the first subsystem 101 in this exemplary embodiment comprises an absolute angle sensor unit 7 which is assigned to the steering shaft 2 and is designed to capture an angle set by means of the steering handle 3 as the absolute steering angle of the steering shaft 2. Moreover, an electric motor 6 of the feedback actuator 5 of the first subsystem 101 is assigned a relative angle sensor unit 4, wherein the relative angle sensor unit 4 is a rotor position sensor in this exemplary embodiment. The relative steering angle of the steering shaft 2 can be captured by means of the rotor position sensor.

The second subsystem 102 of the steer-by-wire steering system 1 comprises a steering actuator unit 9. In this exemplary embodiment, the steering actuator unit 9 comprises a steering pinion 11 and an electric motor 10 driving the steering pinion 11. The steering pinion 11 is driven by the electric motor 10 to convert a steering command into a steering movement of the steerable wheels 14 by corresponding actuation of the steering actuator unit 9. The steering actuator unit 9 acts here by means of the electric motor 10 via the steering pinion 11 on a coupling element 12 designed as a rack and thus triggers a steering movement of the steerable wheels 14 of a motor vehicle, which are in particular connected via tie rods 13 to the coupling element 12. The tie rods 13 themselves are each connected in a known manner via steering knuckles to a steered wheel 14. The second subsystem 102 furthermore comprises an absolute position sensor unit 15 for determining an absolute position of the coupling element 12 and a relative position sensor unit 16 for determining a relative position of the coupling element 12. In this exemplary embodiment, a rotor position sensor assigned to the electric motor 10 of the steering actuator unit 9 is used as the relative position sensor unit 16.

In this exemplary embodiment, the steering actuator unit 9 of the second subsystem 102 provides the energy necessary for the operation of the absolute angle sensor unit 7 comprised by the first subsystem 101 and directly receives the angle measured values which the absolute angle sensor unit 7 supplies. For this purpose, the steering actuator unit 9 is connected via a first direct communication interface 34, which is comprised by the communication channel 18, to the absolute angle sensor unit 7. SENT or SPC is advantageously used as a communication protocol for the transmission of the angle measured values. The angle measured values are then converted by the second subsystem 102 or by a control unit assigned to the second subsystem 102 into corresponding angle information, and transmitted via a high-level communication connection 20 to the first subsystem 101, wherein the first subsystem 101, in particular a control unit assigned to the first subsystem 101, determines the received angle information 31 together with a measured value provided by the relative angle sensor unit 4 an absolute steering shaft angle.

In a similar manner, the first subsystem 101, in particular the feedback actuator 5 of the first subsystem 101, in this exemplary embodiment provides the energy required for the operation of the absolute position sensor unit 15 and directly receives the position measured values which the absolute position sensor unit 15 supplies. For this purpose, the feedback actuator 5 is connected to the absolute angle sensor unit 7 via a second direct communication interface 35 which is likewise comprised by the communication channel 18. SENT or SPC is advantageously used as a communication protocol for the transmission of the position measured values. The position measured values are then converted by the first subsystem 101 or by a control unit assigned to the first subsystem 101 into corresponding position information 32, and transmitted via the high-level communication connection 20 to the second subsystem 102.

The communication connection 20 thus connects the first subsystem 101 and the second subsystem 102 to one another, wherein in particular the position information 32 determined by the first subsystem 101 is transmitted to the second subsystem 102 via the communication connection 20 and the angle information 31 determined by the second subsystem 102 is transmitted to the first subsystem 101.

FIG. 2 shows a further exemplary embodiment for a steer-by-wire steering system 1 designed according to the invention. The steer-by-wire steering system 1 comprises a first subsystem 101, a second subsystem 102, and a third subsystem 103. The first subsystem 101 comprises a steering shaft 2, a steering handle 3 arranged in a rotationally fixed manner at one end of the steering shaft, a feedback actuator 5, an absolute angle sensor unit 7 for determining an absolute steering angle of the steering shaft 2, and a relative angle sensor unit 4 for determining a relative steering angle of the steering shaft 2. The second subsystem 102 comprises a steering actuator unit 9, a coupling element 12, an absolute position sensor unit 15 for determining an absolute position of the coupling element 12, and a relative position sensor unit 16 for determining a relative position of the coupling element 12. The third subsystem 103 comprises an interface 19 to a backup steering system 200, wherein the interface 19 is designed to transmit data to the backup steering system 200.

The backup steering system 200 comprises a braking system 201, a drive system 202, and an active chassis system 203, wherein the backup steering system 200 uses a deliberate actuation of components of the systems 201, 202, 203 in order to cause the motor vehicle to execute a deliberate steering movement in the event of a failure of the second subsystem 202.

The steering system shown in FIG. 2 can also be viewed as an overall steering system 1′, wherein the overall steering system 1′ comprises the steer-by-wire steering system 1 and the backup steering system 200 and therefore comprises the first subsystem 101, the second subsystem 102, and the third subsystem 103.

In the exemplary embodiment shown in FIG. 2, the first subsystem 101, the second subsystem 102, and the third subsystem 103 are connected to one another for a data exchange via a communication connection 20, which can in particular be formed redundantly. This communication connection 20 is designed in this exemplary embodiment such that the first subsystem 101 and the second subsystem 102 are connected to one another via a private communication channel 21 and in addition the first subsystem 101, the second subsystem 102, and the third subsystem 103 are connected to one another via a vehicle communication network 22. The communication connection 20 is insofar arranged above the first layer with respect to the ISO/OSI model.

The steer-by-wire steering system 1 requires absolute values for correct operation, i.e. values which are related to a fixed reference system, for example the neutral position of the steering handle as the 0° steering angle of the steering shaft 2. The feedback actuator 5 without absolute angle sensor unit 7 is designed to perform a relative measurement in that, for example, it uses its sensor for the rotor position of the servo motor as the relative angle sensor unit 4. To be able to use these values, however, an absolute angle sensor unit is required for an initial comparison. As soon as an existing offset between the absolutely determined angle and the relatively determined angle is determined, the actuator can determine the changes of the signal variable solely on the basis of the motor movement. This means that the feedback actuator can determine an absolute angle without an absolute angle sensor unit after the initialization phase.

Since the absolute angle sensor unit 7 is therefore only required for the initialization, in particular upon starting of the motor vehicle, the absolute angle sensor unit 7 is decoupled in this exemplary embodiment from the first subsystem 101, in particular from the feedback actuator 5, and directly connected via a first communication interface 34 to the second subsystem 102, in particular directly to the steering actuator unit 9 of the second subsystem 102. During an initialization phase, the second subsystem 102, in particular the steering actuator unit 9, transmits a measured absolute value for the initial comparison between absolute and relative angle via the private communication channel 21 to the first subsystem 101, in particular the feedback actuator 5. If the feedback actuator 5, which supplies the main signal via its rotor position sensor as the relative angle sensor unit 4, fails, the steering actuator unit 9 continues to supply the required inputs directly from the absolute value generator, thus the absolute angle sensor unit 7.

This applies in a corresponding manner for the determination of the position of the coupling element 12. The steering actuator unit 9 without absolute position sensor unit 15 is designed to perform a relative measurement in that it uses, for example, a sensor for the rotor position of the servo motor as the relative position sensor unit 16. It is also true here that an absolute position sensor unit 15 is required for an initial comparison in order to be able to use the values of the relative position sensor unit 16. As soon as an existing offset between the absolutely determined position of the coupling element 12 and the relatively determined position of the coupling element 12 is determined, the steering actuator unit can determine the changes of the position solely on the basis of the motor movements. The steering actuator unit 9 is therefore designed to determine an absolute position without the absolute position sensor unit 15 after the initialization phase.

Since the absolute position sensor unit 15 is therefore only required for the initialization, in particular upon starting of the motor vehicle, the absolute position sensor unit 15 is decoupled in this exemplary embodiment from the second subsystem 102, in particular from the steering actuator unit 9, and directly connected via a second direct communication interface 35 to the first subsystem 101, in particular the feedback actuator 5 of the first subsystem 101. During an initialization phase, the first subsystem 101, in particular the feedback actuator 5, transmits a measured absolute value for the initial comparison between absolute and relative position via the private communication channel 21 to the second subsystem 101, in particular the steering actuator unit 9. If the steering actuator unit 9, which also supplies the main signal via its rotor position sensor as the relative position sensor unit 16, fails, the first subsystem 101 continues to supply the required inputs directly from the absolute value generator, thus the absolute position sensor unit 15. The signals required for steering the motor vehicle are then advantageously transmitted via the vehicle communication network 22 to the third subsystem 103 and therefore to the backup steering system 200.

For operation of the steer-by-wire steering system 1 in the error-free case, it is provided that the steering actuator unit 9 of the second subsystem 102 reads absolute measured values, related to the angle of the steering shaft set by means of the steering handle, from the absolute angle sensor unit 7, converts them into correct angle information, and provides the result via the private communication channel 21 and the vehicle communication network 22.

In the meantime, the first subsystem 101, in particular the feedback actuator 5, reads absolute measured values, related to the absolute position of the coupling element 12, from the absolute position sensor unit 15, converts them into suitable position information, and provides the result via the private communication channel 21 and the vehicle communication network 22.

The second subsystem 102, in particular the steering actuator unit 9, reads the absolute position information from the private communication channel 21 and/or the vehicle communication network 22 and compares the relative position measurement which is performed by the second subsystem 102 and is based on measured values of the rotor position sensor 16, and thus obtains position data with respect to the absolute position of the coupling element, and therefore in particular data with respect to a set wheel steering angle of the steerable wheels 14, with better quality, which is to be attributed to the high resolution of the rotor position measurement.

The first subsystem 101, in particular the feedback actuator 5, reads the absolute angle information with respect to a set steering angle of the steering shaft 2 via the private communication channel 21 and/or via the vehicle communication network 22 and compares this information with the relative angle measurements which are performed by the first subsystem 101 and are based on the measured values captured by the rotor position sensor assigned to the electric motor 6 of the feedback actuator 5 as the relative angle sensor unit 4. In this way, the first subsystem determines absolute angle information with respect to a set steering angle of the steering shaft 2 with better quality, which is to be attributed to the high resolution of the rotor position measurement.

In this way, the first subsystem 101 and the second subsystem 102, in particular the feedback actuator 5 and the steering actuator unit 9, obtain the correct absolute information with respect to the angle of the steering shaft 2 or with respect to the position of the coupling element 12. A steering specification can then be set by means of the steering handle 3.

In the event of a failure of the first subsystem 101, the first subsystem 101 can no longer supply absolute steering wheel angle information, but the second subsystem, in particular the steering actuator unit 9, can continue to be operated, because the information required for the operation can continue to be provided. Absolute position information with respect to the position of the coupling element 12 is thus available by means of the rotor position sensor used as the relative position sensor unit 16, wherein the required comparison between absolute position measured value and relative position measured value was already performed in error-free operation during the start. The information with respect to the absolute angle of the steering shaft 2 is moreover provided directly by the absolute angle sensor unit 7. A wheel steering angle of the steered wheels 14 can thus continue to be set by means of the steering actuator unit 9 according to a specification.

In the event of a failure of the second subsystem 102, and therefore a failure of the steering actuator unit 9, a wheel steering angle of the steerable wheels 14 can no longer be set via the steering actuator unit 9 to implement a steering specification. A steering specification is now implemented by a backup steering system 200, wherein in particular the motor vehicle is maneuvered by deliberate braking of individual wheels and/or a deliberate application of drive torques to individual wheels and/or by deliberate actuation of components of an active chassis assigned to the wheels. For this purpose, the backup steering system 200 requires both information with respect to the position of the coupling element 12 as information with respect to the angle of the steering shaft 2 and therefore the steering handle 3. This information is provided by the first subsystem 101 via the vehicle communication network 22 to the third subsystem 103, wherein the information is provided in particular via the interface 19 to the backup steering system 200. An absolute angle of the steering shaft 2 can provide the first subsystem 101 here on the basis of the measurements performed by means of the relative angle sensor unit 4, wherein the comparison between absolute and relative measured value was already performed during the startup in error-free operation. The first subsystem 101 continues to capture measured values with respect to the absolute position of the coupling element 12 via the absolute position sensor unit 15, wherein the first subsystem 101 converts the captured measured values into absolute position information with respect to the position of the coupling element 12, and likewise provides this position information as sensor data via the vehicle communication network 22 for use by the backup steering system 200.

A further exemplary embodiment for a method designed according to the invention for operating a steer-by-wire steering system, in particular a steer-by-wire steering system which can be designed as shown in FIG. 2, will be explained with reference to FIG. 3. FIG. 3 shows a simplified block diagram for this purpose.

The method provides that in a first operating mode BM1, which is configured for error-free operation, the second subsystem 102 captures (A) an angle measured value provided by the absolute angle sensor unit 7 via a first communication interface 34, converts (B) the captured angle measured value into corresponding angle information 31, and provides (C) the angle information 31 to the first subsystem 101 via the communication connection 20. The first subsystem 101 captures (D) the angle information 31 provided via the communication connection 20 and determines (E) an absolute steering shaft angle from this angle information 31 and a relative angle of the steering shaft 2 captured by means of the relative angle sensor unit 4. Moreover, the first subsystem 101 captures (F) a position measured value provided by the absolute position sensor unit 15 via a second communication interface 35, converts (G) the captured position measured value into corresponding position information 32 with respect to a position of the coupling element 12, and provides (H) the position information 32 to the second subsystem 102 via the communication connection 20. The second subsystem 102 captures (K) the position information 32 provided via the communication connection 20 and determines (L) an absolute coupling element position from this position information 32 and a relative position of the coupling element 12 captured by means of the relative position sensor unit 16.

If an error is detected in the first subsystem 101, so that in particular the first subsystem 101 cannot provide position information 32, the steer-by-wire steering system thus changes (M) to a second operating mode BM2. The second subsystem 102 determines (P) the absolute coupling element position based on a relative position of the coupling element 12 captured by means of the relative position sensor unit 16 and a previously determined absolute coupling element position. Moreover, the second subsystem 102 captures information with respect to an absolute angle of the steering shaft 2 directly from the absolute angle sensor unit 7 via the communication connection 20. Using this information, the steering actuator unit 9 of the second subsystem 102 continues to be operated (R) to set a wheel steering angle of the steered wheels 14.

In contrast, if an error is detected in the second subsystem 102, so that a wheel steering angle can no longer be set by means of the steering actuator unit 9, the steer-by-wire steering system thus changes (N) to a third operating mode BM3. In this third operating mode BM3, the first subsystem 101 determines(S) an absolute angle of the steering shaft 2 based on a relative angle of the steering shaft 2 captured by means of the relative angle sensor unit 4 and a previously determined absolute steering shaft angle. Furthermore, the first subsystem 101 captures (F′) as in the first operating mode BM1 a position measured value provided by the absolute position sensor unit 15 and converts (G′) the captured position measured value into corresponding position information 32 with respect to a position of the coupling element 12. The first subsystem 101 then provides (T) the determined absolute angle 33 of the steering shaft 2 and the converted position information 32 to the third subsystem 103. The interface 19 of the third subsystem 103 forwards (U) the determined absolute angle 33 and the position information 32 to the backup steering system (200), which steers (V) the motor vehicle in consideration of the received information 32, 33.

The exemplary embodiments shown in the figures and explained in conjunction therewith serve to explain the invention and are not restrictive therefor.

### LIST OF REFERENCE SIGNS

1 steer-by-wire steering system
1′ overall steering system
2 steering shaft
3 steering handle
4 relative angle sensor unit
5 feedback actuator
6 electric motor of the feedback actuator (5)
7 absolute angle sensor unit
8 steering gear
9 steering actuator unit
10 electric motor of the steering actuator unit (9)
11 steering pinion
12 coupling element
13 tie rod
14 steerable wheel
15 absolute position sensor unit
16 relative position sensor unit
18 direct communication channel
19 interface
20 communication connection
21 private communication channel
22 vehicle communication network
31 angle information
32 position information
33 determined absolute angle
34 first direct communication interface
35 second direct communication interface
101 first subsystem
102 second subsystem
103 third subsystem
103′ third subsystem (with backup steering system (200))
200 backup steering system
201 braking system
202 drive system
203 active chassis
BM1/2/3 first/second/third operating mode
A to V method steps

1-16. (canceled)

17. A steer-by-wire steering system for a motor vehicle, comprising:
a first subsystem; and
a second subsystem;
wherein the first subsystem includes:
a steering shaft;
a steering handle arranged in a rotationally fixed manner at one end of the steering shaft;
a feedback actuator;
an absolute angle sensor unit for determining an absolute steering angle of the steering shaft; and
a relative angle sensor unit for determining a relative steering angle of the steering shaft;
wherein the second subsystem includes:
a steering actuator unit;
a coupling element;
an absolute position sensor unit for determining an absolute position of the coupling element; and
a relative position sensor unit for determining a relative position of the coupling element;
wherein the first subsystem and the second subsystem are connected to one another via a communication connection configured to transmit sensor data from the first subsystem to the second subsystem and to transmit sensor data from the second subsystem to the first subsystem.

18. The steer-by-wire steering system as claimed in claim 17, further comprising a third subsystem, wherein the third subsystem comprises an interface to a backup steering system, and wherein the communication connection is furthermore configured to transmit sensor data from the first subsystem and/or from the second subsystem to the third subsystem, and wherein the interface is configured to transmit sensor data transmitted to the third subsystem to the backup steering system.

19. The steer-by-wire steering system as claimed in claim 17, wherein the communication connection is implemented by a vehicle communication network and/or is implemented by a private communication channel between the subsystems.

20. The steer-by-wire steering system as claimed in claim 17, wherein the second subsystem is designed to receive angle measured values provided by the absolute angle sensor unit via a first direct communication interface.

21. The steer-by-wire steering system as claimed in claim 17, wherein the second subsystem is designed to provide the absolute angle sensor unit with the energy required for operation via the first direct communication interface.

22. The steer-by-wire steering system as claimed in claim 17, wherein the first subsystem is designed to receive position measured values provided by the absolute position sensor unit via a second direct communication interface.

23. The steer-by-wire steering system as claimed in claim 17, wherein the first subsystem is designed to provide the absolute position sensor unit with the energy required for operation via the second direct communication interface.

24. The steer-by-wire steering system as claimed in claim 17, wherein the steer-by-wire steering system is designed for operation in a motor vehicle in different operating modes, wherein the steer-by-wire steering system is configured in a first operating mode for error-free operation, the steer-by-wire steering system is configured in a second operating mode for operation in the event of a failure of the first subsystem, and the steer-by-wire steering system is designed in a third operating mode for operation in the event of a failure of the second subsystem.

25. The steer-by-wire steering system as claimed in claim 17, wherein the communication connection is redundantly designed.

26. A method for operating a steer-by-wire steering system as claimed in claim 17 in a motor vehicle, wherein in a first operating mode configured for error-free operation, the second subsystem captures an angle measured value provided by the absolute angle sensor unit, the second subsystem converts the captured angle measured value into corresponding angle information, and the second subsystem provides the angle information via the communication connection to the first subsystem.

27. The method as claimed in claim 26, wherein the first subsystem captures the angle information provided via the communication connection and determines an absolute steering shaft angle from this angle information and a relative angle of the steering shaft captured by means of the relative angle sensor unit.

28. The method as claimed in claim 26, wherein in the first operating mode configured for error-free operation, the first subsystem captures a position measured value provided by the absolute position sensor unit, the first subsystem converts the captured position measured value into corresponding position information with respect to a position of the coupling element, and the first subsystem provides the position information via the communication connection to the second subsystem.

29. The method as claimed in claim 28, wherein the second subsystem captures the position information provided via the communication connection and determines an absolute coupling element position from this position information and a relative position of the coupling element captured by means of the relative position sensor unit.

30. The method as claimed in claim 28, wherein in a third operating mode, in which the motor vehicle is steered by means of a backup steering system because of an error in the second subsystem, the first subsystem determines an absolute angle of the steering shaft based on a relative angle of the steering shaft captured by means of the relative angle sensor unit and a previously determined absolute steering shaft angle, this determined absolute angle of the steering shaft is provided together with the converted position information to the third subsystem, wherein the interface of the third subsystem forwards the determined absolute angle and the position information to the backup steering system.

31. The method as claimed in claim 26, wherein in a second operating mode, in which the first subsystem cannot provide position information due to an error in the first subsystem, the second subsystem determines the absolute coupling element position based on a relative position of the coupling element captured by means of the relative position sensor unit and a previously determined absolute coupling element position, wherein information with respect to an absolute angle of the steering shaft is captured directly by the absolute angle sensor unit.
